(19) United States
(12) Patent Application Publication
(10) Pub. No.: US 2022/0027872 A1
(43) Pub. Date: Jan. 27, 2022

(54) DIGITIZATION OF NON-PERSONAL ACCOUNT INFORMATION FOR SECURITY OF FINANCIAL IDENTITY DATA IN THIRD-PARTY PAYMENT PROCESSING SYSTEMS

(71) Applicant: MASTERCARD INTERNATIONAL INCORPORATED, Purchase, NY (US)

(72) Inventors: Nilesh Tulsidas Upadhye, Chelmsford (GB); Joseph D. Hayes, Montclair, NJ (US)

(21) Appl. No.: 16/935,570

(22) Filed: Jul. 22, 2020

(51) Int. Cl. G06Q 20/10; H04L 29/06; G06Q 20/38; G06Q 20/36; G06Q 40/02; G06Q 30/00; G06Q 50/26

(52) U.S. Cl. CPC G06Q 20/108; H04L 63/0853; G06Q 20/385; G06Q 2220/00; G06Q 40/02; G06Q 30/0185; G06Q 50/265; G06Q 20/3672

(57) ABSTRACT

Techniques for digitization of non-personal account information for security of financial identity data in third-party payment processing systems are described. A bank system can send a non-personal account reference number, in place of a personal account number, to serve as an identifying characteristic for a user. Unlike the personal account number, the account reference number is not personal account information, thus reducing security requirements, including PCI DSS, and overall exposure risk for financial identity data. During the described digitization, the third-party system can receive a communication comprising at least an account reference number from a bank system. The third-party system can create a digitized account reference token for the account reference number; and store the digitized account reference token mapped to the account reference number in a token vault. The third-party system can provision the digitized account reference token to one or more user devices to be used for payment.

### BACKGROUND

Maintaining payment security is required for all entities that accept, store, process, or transmit payment card information. Guidance for maintaining payment security is provided by Payment Card Industry Data Security Standards (PCI DSS). The PCI DSS is administered by the Payment Card Industry Security Standards Council (PCI SSC), an independent body created and populated by major payment card brands including Visa, MasterCard, American Express, Discover, and JCB. The PCI SSC is responsible for managing the PCI DSS, while compliance is enforced by the payment card brands and acquirers. Failure to abide by the PCI DSS can result in heavy fines or blacklisting from major payment card brands.

Information protected by the PCI DSS includes financial identity data, such as personal account information. Personal account information includes, but is not limited to, primary account number (PAN), payment card number, card verification value (CVV), expiration date, and service code.

Security requirements defined in the PCI DSS can be generally classified into six main security objectives: build and maintain a secure network, protect cardholder data, maintain a vulnerability management program, implement strong access control measures, regularly monitor and test networks, and maintain an information security policy. There are a variety of ways to achieve the objectives outlined in the PCI DSS, but generally they involve either not storing sensitive financial identity data or storing sensitive financial identity data in a secure environment, leaving default aspects of programs at high security levels, and rigorously monitoring for activity in a system. These requirements of the PCI DSS can be costly or otherwise difficult to meet.

### BRIEF SUMMARY

Techniques for digitization of non-personal account information for security of financial identity data in third-party payment processing systems are described herein. Through the described digitization of non-personal account information, a bank system can send a non-personal account reference number to a third-party payment processing system (“third-party system”), including a digitization service or token vault, in place of a personal account number to serve as an identifying characteristic for a user. Indeed, unlike the personal account number, the described account reference number is not financial identity data. Advantageously, security requirements on the side of the third-party system can be reduced, including PCI DSS. Additionally, overall exposure risk for financial identity data, such as the personal account number, can also be reduced.

During the described digitization of non-personal account information, a third-party system can receive a communication comprising at least an account reference number from a first system, such as a bank system. The account reference number is not financial identity data. The third-party system can create a digitized account reference token for the account reference number; and store the digitized account reference token mapped to the account reference number in a token vault. The third-party system can provision the digitized account reference token to one or more user devices to be used for payment.

The third-party system can receive, from an acquirer, transaction details, including at least the digitized account reference token. The third-party system can use the digitized account reference token to identify the account reference number from the token vault, as well as determine a bank system corresponding to the account reference number. The third-party system can then communicate the transaction details and account reference number to the bank system.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example operating environment and signal flow for account reference digitization.

FIG. 2 illustrates an example operating environment for a payment flow with a digitized account reference.

FIG. 3 illustrates an example process flow for account reference digitization according to an embodiment of the invention.

FIG. 4 illustrates an example process flow for account reference digitization according to an embodiment of the invention.

FIG. 5 illustrates components of a computing system that may be used in certain embodiments described herein.

### DETAILED DESCRIPTION

Techniques for digitization of non-personal account information for security of financial identity data in third-party payment processing systems are described herein. Through the described digitization of non-personal account information, a bank system can send a non-personal account reference number to a third-party payment processing system (“third-party system”), including a digitization service or token vault, in place of a personal account number to serve as an identifying characteristic for a user. Indeed, unlike the personal account number, the described account reference number is not financial identity data. Advantageously, security requirements on the side of the third-party system can be reduced, including PCI DSS. Additionally, overall exposure risk for financial identity data, such as the personal account number, can also be reduced.

During the described digitization of non-personal account information, a third-party system can receive a communication comprising at least an account reference number from a first system, such as a bank system. The account reference number is not financial identity data. The third-party system can create a digitized account reference token for the account reference number; and store the digitized account reference token mapped to the account reference number in a token vault. The third-party system can provision the digitized account reference token to one or more user devices to be used for payment.

The third-party system can receive, from an acquirer, transaction details, including at least the digitized account reference token. The third-party system can use the digitized account reference token to identify the account reference number from the token vault, as well as determine a bank system corresponding to the account reference number. The third-party system can then communicate the transaction details and account reference number to the bank system.

Typical existing digital mobile payment solutions require a user's personal account information to digitize the account for mobile based contactless or in-application payments. That is, conventionally, the bank system needs to share the user's actual personal account numbers with a third-party system who then performs account digitization on behalf of the bank system. This personal account number is considered financial identity data. Sharing the user's personal account information raises financial information identity theft risk in case of any cyber security incident, as well as data privacy concerns.

Advantageously, through the described techniques, mobile payments can use a digitized account reference number instead of a digitized personal account number, thus minimizing financial information identity theft risk and data privacy concerns.

To digitize a user account, the consumer bank system can create an account reference number which does not have any business significance to external entities, such as a third-party system, who then digitizes the account reference number for mobile payments. When the user performs mobile payment transaction using the digitized account reference number, the third-party system can de-tokenize the transaction to get the corresponding account reference number. The account reference can be passed to the bank system to move the funds from the user's account to the acquirer's account. The bank system can identify the actual user account number based on the third-party system provided account reference number in the transaction.

A “merchant” refers to a provider of goods or services in exchange for payment. The merchant can be physically present at the sale or remote, such as an online retailer. An “acquirer” refers to a party that processes payments on behalf of the merchant in a payment card transaction. The acquirer can be a bank system or other institution associated with the merchant.

An “issuer” refers to a bank system or other institution that provides payment cards to the cardholder.

The terms “user” and “consumer” are used interchangeably herein. The terms “account reference” and “account reference number” are used interchangeably herein.

The term “personal account number” refers to a financial account number, such as, but not limited to, a bank account number, a PAN, and a payment card number. For the purpose of this disclosure, the personal account number is considered financial identity data or personal account information. The terms “personal account number” and “account number” are used interchangeably herein.

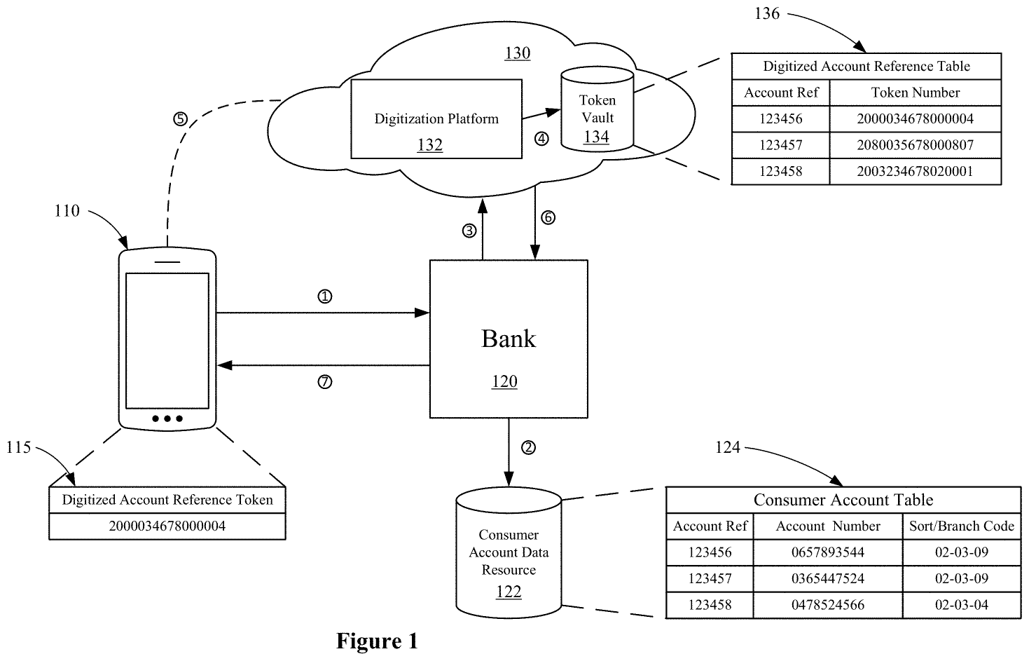

FIG. 1 illustrates an example operating environment and signal flow for account reference digitization. Referring to FIG. 1, an example operating environment can include a user device 110, a bank system 120, and a third-party payment processing system (“third-party system”) 130.

The user device 110 may be, but is not limited to, a personal computer, a laptop computer, a desktop computer, a tablet computer, a reader, a mobile device, a personal digital assistant, a smart phone, a gaming device or console, a wearable computer, a wearable computer with an optical head-mounted display, computer watch, a whiteboard, or a smart television.

The user device 110 can run an application, such as a mobile banking application managed by a bank system (e.g., bank system 120). One or more digitized payment tokens can be provisioned into the user device 110, enabling users to perform payments via existing contactless point-of-sale (POS) systems, or via remote payment use case s such as in-app payments. Examples of digitized payment tokens include, but are not limited to, PAN tokens and digitized account reference tokens. The user device 110 can include or communicate with one or more data resources storing the one or more digitized payment tokens.

In the illustrative example, digitized account reference token 115 having the token number of “2000034678000004” is provisioned to the user device 110 and can be used for mobile payments.

A bank system (e.g., bank system 120) can be a financial institution through which the user has an account. In some cases, the bank system may be the issuer that provides the payment card being digitized to the user. Conventionally, a bank system includes or communicates with one or more data resources to manage user account information, such as the PAN. However, in order to perform the described digitization of non-personal account information, changes in the management of user account information are performed. In particular, each account number is stored along with a corresponding an account reference number

In the example operating environment, the bank system 120 includes or communicates with one or more data resources, such as consumer account data resource 122. The consumer account data resource 122 can store one or more data sets, including, for example, a consumer account table 124. The consumer account table 124 provides a mapping of an account reference number, a personal account number, and a sort/branch code for one or more accounts.

With the addition of the account reference number, the bank system 120 no longer needs to share a user's actual financial identity data, such as the personal account number. Instead, the bank system 120 can share the account reference number, which does not contain any personal account information.

The third-party system 130 can be a system or service that is responsible for digitization and tokenization of forms of payment. In some cases, the third-party system 130 is associated with the bank system 120. In some cases, the third-party system 130 is separate institution from the bank system 120 and handles the digitization and tokenization processes. The third-party system 130 can include or communicate with a digitization platform 132 and one or more data resources, such as token vault 134.

A token vault refers to a repository where issued digitized payment tokens and corresponding personal account numbers and account reference numbers are securely stored. In some cases, a token vault stores both personal account numbers and account reference numbers with corresponding tokens. In this case, the token vault may store the personal account number and corresponding tokens in a separate area of the token vault than the account reference numbers and corresponding tokens.

In some cases, a token vault stores only account reference numbers and corresponding tokens. As previously described, account reference numbers do not contain any financial identity data, such as personal account information. Since account reference numbers do not contain any financial identity data, account reference numbers do not fall into the covenants of PCI DSS. Thus, the security requirements for the token vault are reduced.

In the example operating environment, the token vault 134 includes one or more data sets, including digitized account reference table 136 that contains mappings of account reference numbers and corresponding token for one or more accounts.

Components (computing systems, storage resources, and the like) in the operating environment may operate on or in communication with each other over a network (not shown). The network can be, but is not limited to, a cellular network (e.g., wireless phone), a point-to-point dial up connection, a satellite network, the Internet, a local area network (LAN), a wide area network (WAN), a Wi-Fi network, an ad hoc network or a combination thereof. Such networks are widely used to connect various types of network elements, such as hubs, bridges, routers, switches, servers, and gateways. The network may include one or more connected networks (e.g., a multi-network environment) including public networks, such as the Internet, and/or private networks such as a secure enterprise private network. Access to the network may be provided via one or more wired or wireless access networks as understood by those skilled in the art.

Communication to and from the components, such as from the bank system and the third-party system, may be carried out, in some cases, via application programming interfaces (APIs). An API is an interface implemented by a program code component or hardware component (hereinafter “API-implementing component”) that allows a different program code component or hardware component (hereinafter “API-calling component”) to access and use one or more functions, methods, procedures, data structures, classes, and/or other services provided by the API-implementing component. An API can define one or more parameters that are passed between the API-calling component and the API-implementing component. The API is generally a set of programming instructions and standards for enabling two or more applications to communicate with each other and is commonly implemented over the Internet as a set of Hypertext Transfer Protocol (HTTP) request messages and a specified format or structure for response messages according to a REST (Representational state transfer) or SOAP (Simple Object Access Protocol) architecture.

During an example account reference number digitization, a user can use the user device 110 to select a personal account number to digitize for mobile payments. The user device 110 can communicate the selection to the bank system 120, as reflected by flow 1. In the illustrative example, the user selects personal account number “0657893544” to be digitized for mobile payments.

In some cases, the communication can be initiated by the user through an application, such the mobile banking application, that is hosted on the user device 110. In some cases, the communication can be initiated by the user through a portal or website accessed by the user device 110. In some cases, the application, portal, or website can be managed by the bank system 120 and only usable for users that have accounts at the bank system 120.

The bank system 120 can retrieve an account reference number from the consumer account table 124 in the consumer account data resource 122 that corresponds to the personal account number chosen by the user, as reflected by flow 2. In the illustrative example, the bank system 120 retrieves account reference number “123456” that corresponds to the selected personal account number “0657893544.”

The bank system 120 can then communicate a request or instruction to the third-party system 130 to digitize the account reference number, as reflected by flow 3. In the illustrative example, the bank system 120 instructs the third-party system 130 to digitize account reference number “123456.”

Conventionally, a bank system communicates an instruction to a third-party system to digitize the personal account number. The conventional communication between the bank system and the third-party system includes the actual personal account number. This communication of the actual personal account number raises privacy concerns and financial identity theft risk.

Advantageously, in flow 3, the account reference number is communicated between the bank system and the third-party system instead of the actual account information. In the case of a security incident at the third-party system, financial identity theft and privacy concerns can be prevented since the third-party system only holds the account reference number of a user and the account reference number does not contain any financial identity data.

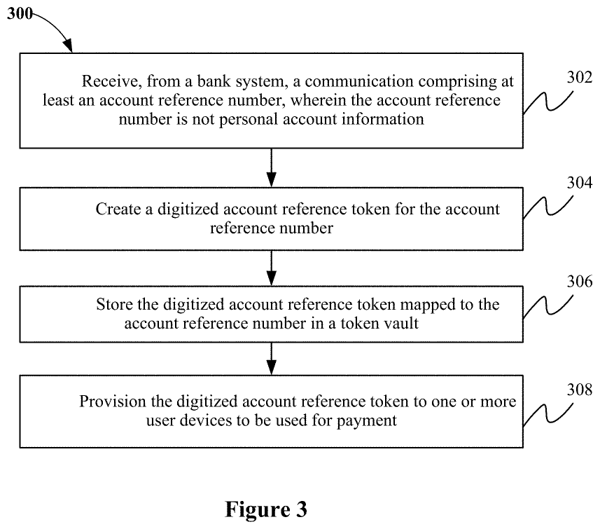

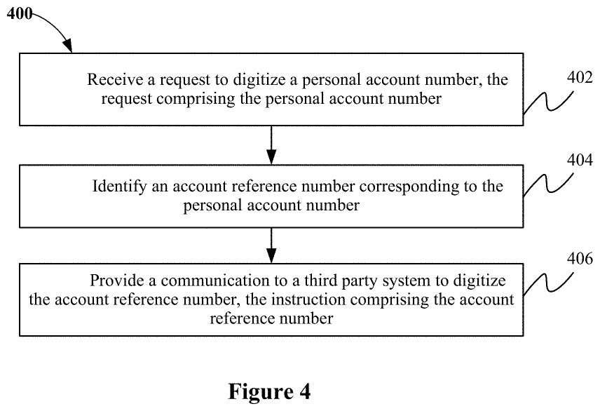

A more detailed discussion of the communication between the bank system and the third-party system is discussed with respect to FIG. 3 and FIG. 4.

The third-party system 130 can receive the communication and initiate the digitization process. The digitization platform 132 can tokenize the account reference number by creating a digitized account reference token corresponding to the account reference number. The digitized account reference token replaces the account reference number with a unique token, which represents the account reference number but provides additional security benefits. In the illustrative example, the third-party system 130 digitizes account reference number “123456” and creates the digitized account reference token “2000034678000004.”

The digitized account reference token and the account reference number can be paired or otherwise mapped to each other and stored in the digitized account reference table 136 in the token vault 134, as reflected by flow 4. Once the digitized account reference token is created and mapped to the account reference number, the digitized account reference token can be provisioned on the user device 110, as reflected by flow 5.

A more detailed discussion of the steps taken by the third-party system 130 during a digitization process is provided in FIG. 3.

In some cases, once the digitized account reference token is provisioned, the third-party system 130 can communicate a confirmation to the bank system 120. The communication can be, for instance, a signal indicating success or failure. In another example, the third-party system 130 can be configured to send a communication to the bank system 120 if the process was a success or if the process was a failure. The bank system 120 can then communicate a confirmation to the user device 110. The communication between the bank system 120 and the user device 110 can vary in a similar manner to the communication between the third-party system 130 and the bank system 120.

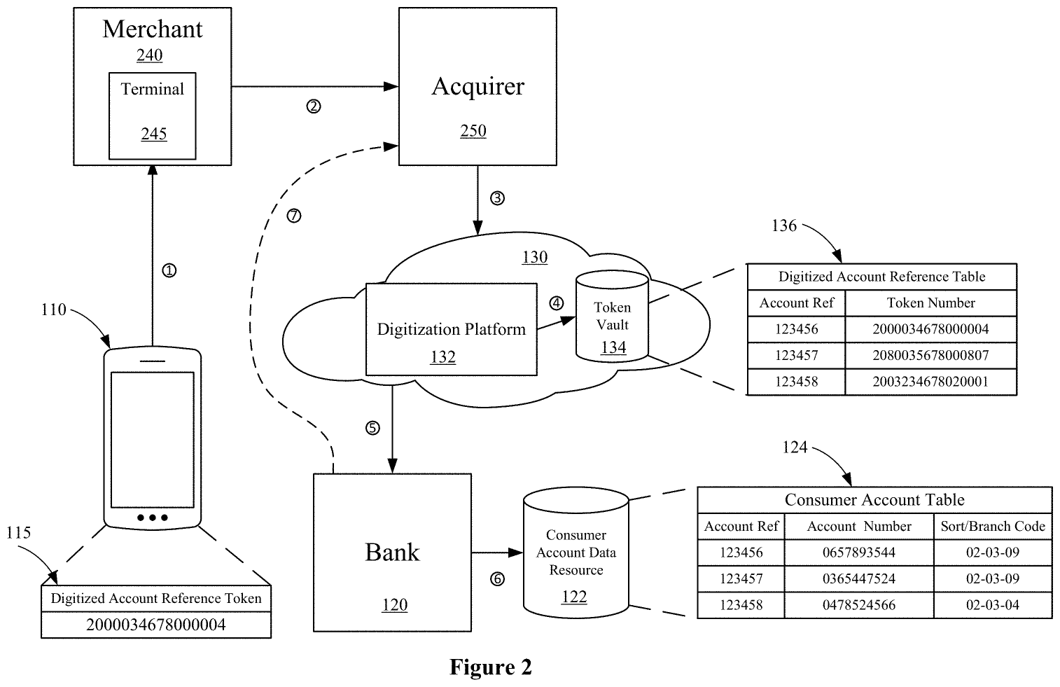

FIG. 2 illustrates an example operating environment for a payment flow with a digitized account reference. Referring to FIG. 2, an example operating environment can include the user device 110, the bank system 120, and the third-party system 130, as described with respect to FIG. 1, as well as a merchant 240 having a terminal 245, and an acquirer 250.

As described in FIG. 1, digitized account reference token 115 having the token number of “2000034678000004” is provisioned to the user device 110 and can be used for mobile payments.

As described in FIG. 1, the bank system 120 can be a financial institution through which the user has an account. In some cases, the bank system 120 may be the issuer that provides the payment card being digitized to the user. The bank system 120 includes or communicates with one or more data resources, such as consumer account data resource 122. The consumer account data resource 122 can store one or more data sets, including, for example, a consumer account table 124. The consumer account table 124 provides a mapping of an account reference number, a personal account number, and a sort/branch code for one or more accounts.

With the addition of the account reference number, the bank system 120 no longer needs to share a user's actual financial identity data, such as the personal account number. Instead, the bank system 120 can share the account reference number, which does not contain any personal account information.

As described in FIG. 1, the third-party system 130 can be a system or service that provides digitization and tokenization of different forms of payment. In some cases, the third-party system 130 is associated with the bank system 120. In some cases, the third-party system 130 is a separate institution from the bank system 120 and handles the digitization and tokenization processes. The third-party system 130 can include or communicate with a digitization platform 132 and one or more data resources, such as token vault 134. The token vault 134 includes one or more data sets, including digitized account reference table 136 that contains mappings of account reference numbers and corresponding token for one or more accounts.

The terminal 245 can be used to process card payments for a merchant (e.g., merchant 240). Examples of the terminal 245 include, but are not limited to, a point-of-sale (POS) terminal or an e-commerce website. The terminal 245 can be operated by the merchant 240 and can be configured to accept contactless or cardless payments. The acquirer 250 can be a financial institution associated with the merchant 240 who operates the terminal 245. The acquirer 250 can handle payment card transactions and act as a counterparty to the bank system 120, as is typical in payment card transactions.

The example payment flow for a digitized account reference may begin when a user makes a purchase, for example by tapping the user device 110 on the terminal 245 or paying within a mobile app. The user device 110 responds to the purchase request from the user by providing transaction details, including the user's tokenized account reference number (digitized account reference token 115) and a transaction cryptogram, which acts as a one-time use password, to the terminal 245 at the merchant 240, as reflected by flow 1.

The terminal 245 can transmit the transaction details to the acquirer 250, as reflected by flow 2. The acquirer 250 can then route the transaction details to the third-party system 130, as reflected by flow 3.

Once the third-party system 130 receives the transaction details, including the digitized account reference token, the third-party system 130 can communicate with the token vault 134 to de-tokenize the digitized account reference token to determine the corresponding account reference number, and thus the financial institution or issuer, associated with the user and account reference number, as reflected by flow 4.

In the illustrative example, the digitized account reference token 115 (“2000034678000004”) corresponds to account reference number “123456,” which was digitized and stored in the token vault 134. From the account reference number “123456,” the third-party system 130 can determine that the bank system 120 is the financial institution in which the account reference number “123456” belongs.

The third-party system 130 can then communicate the transaction details and the account reference number to the bank system 120, as reflected by flow 5. The communication between the third-party system 130 and the bank system 120 does not include any financial identity data. Indeed, the communication includes the account reference number instead of the actual personal account number, and the account reference number is not personal account information.

The bank system 120 can then determine the user's personal account number associated with the account reference number by communicating with the consumer account data resource 122, as reflected by flow 6. Once the bank system 120 determines the user's personal account number, the bank system 120 can then transfer the funds from the user's account to the acquirer 250, and thus the acquirer's account, as reflected by flow 7.

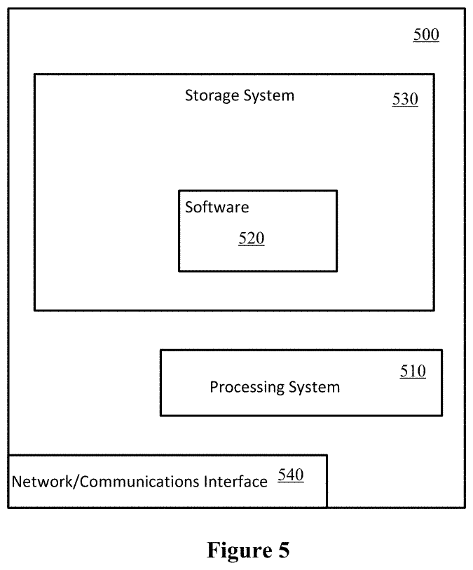

FIG. 3 illustrates an example process flow diagram for account reference digitization according to an embodiment of the invention. Referring to FIG. 3, a third-party system, executing a digitization platform, performing process 300, can be implemented by a system embodied as described with respect to system 500 shown in FIG. 5.

In some cases, the digitization platform may be a part of the third-party system. In some cases, the digitization platform may be a separate system in communication with the third-party system.

Referring to process 300, the third-party system can receive (302) a communication from a first system, such as a bank system (e.g., bank system 120 as described with respect to FIGS. 1 and 2). The communication can include at least an account reference number. As previously described, the account reference number is not financial identity data, such as a PAN.

Conventionally, the communication received from the bank system would include a personal account number. However, during process 300, the conventional communication is modified to include the account reference number instead of personal account number. The conventional communication can be modified a variety of ways in order to include the account reference number.

In some cases, the standard format of the communication can be used. In this case, the account reference number can be included in the communication in place of the personal account number. For example, the account reference number can have the same number of characters as the personal account number and can be included in a field assigned to the personal account number. The communication can include a notification (e.g., a flag) to notify the third-party system that the account reference number is included in the communication in place of the personal account number. Indeed, the data type of the field can be announced to indicate whether the account reference number or the personal account number is included.

In some cases, the standard format of the communication can be modified. For example, the account reference number can be appended as a field at the end of the communication, with other parts of the communication being according to an existing procedure. In this case, the field assigned to the personal account number would be left empty.

Through the communication, the third-party system can recognize that the communication received from the bank system is no longer the standard personal account number and is instead a non-personal account reference number. Since the account reference number is not personal account information, the third-party system is alleviated from the PCI DSS requirements, resulting in lower costs to the third-party system. Further, with the non-personal account reference number, the third-party system can manage a token vault storing information that, if stolen, would be rendered useless by the fact that the stored information is not personal account information.

Once the communication is received (302), the third-party system can create (304) a digitized account reference token for the account reference number. In some cases, tokenization can occur at runtime. In some cases, the third-party system can assign pre-generated token numbers to account reference numbers as they are received.

After a digitized account reference token is created (304), the digitized account reference token can be stored (306) mapped to the account reference number in a token vault. As previously described, the third-party system can include or communicate with one or more data resources having one or more data sets, such as the token vault having a digitized account reference table that contains mappings of account reference numbers and corresponding token for one or more accounts.

The third-party system can provision (308) the digitized account reference token to one or more user devices to be used for payment. User devices for which a digitized account reference token can be provisioned can include, for example, user device 110 described with respect for FIGS. 1 and 2. The provisioning can be performed by communicating the digitized account reference token to the user device. In some cases, the digitized account reference token may be provisioned to one user device. In some cases, the digitized account reference token may be able to be provisioned on multiple user devices.

In some cases, after the digitized account reference token is provisioned (308) to one or more user devices, the third-party system can confirm to the bank system that the digitized account reference token has been created. The confirmation can be performed in a variety of manners. In some cases, a communication specifically indicating success or failure can be sent to the bank system. In some cases, the confirmation can be implicitly performed, such as if the protocol calls for a communication to be sent only in the event of one of success or failure. The communication can also include which of one or more user devices have been provisioned.

After the digitized account reference token is provisioned (308) to one or more user devices, a user can make mobile payments using the digitized account reference. When the user makes a mobile payment, the third-party system can receive transaction details, including at least the digitized account reference token, from an acquirer.

Once the third-party system receives the transaction details, including the digitized account reference token, the third-party system can communicate with the token vault to de-tokenize the digitized account reference token to determine the corresponding account reference number, and thus the financial institution or issuer, associated with the user and account reference number. For example, the third-party system can identify the account reference number from the token vault using the digitized account reference token and determine the bank system corresponding to the account reference number.

The third-party system can then communicate the transaction details and the account reference number to the bank system. The communication between the third-party system and the bank system does not include any financial identity data. Indeed, the communication includes the account reference number instead of the actual personal account number, and the account reference number is not financial identity data.

FIG. 4 illustrates an example process flow diagram for account reference digitization according to an embodiment of the invention. Referring to FIG. 4, a bank system, such as bank system 120 described with respect to FIGS. 1 and 2, performing process 400, can be implemented by a system embodied as described with respect to system 500 shown in FIG. 5.

Referring to process 400, the bank system can receive (402) a request to digitize a personal account number. For example, a user may request to digitize a payment card in order to make a mobile payment. The request can include the personal account number.

The bank system can identify (404) an account reference number corresponding to the personal account number received in step 402.

As previously discussed, the bank system includes or communicates with one or more data resources, such as a consumer account data resource. The consumer account data resource can store one or more data sets, including, for example, a consumer account table. The consumer account table provides a mapping of an account reference number, a personal account number, and a sort/branch code for one or more accounts.

In some cases, the bank system can query a consumer account table using the received personal account number to identify the account reference number.

In some cases, the bank system can create an account reference number for the received personal account number when the bank system receives the request. The bank system can then store the created account reference number with the corresponding personal account number in the consumer account data resource.

The bank system can provide (406) a communication to a third-party system to digitize the account reference number. The communication includes the account reference number. In some cases, the communication is a request or an instruction to the third-party system to digitize the account reference number.

Conventionally, the communication sent from the bank system would include the personal account number and an instruction to digitize that personal account number. However, during process 400, the conventional communication is modified to include the account reference number and an instruction to digitize that account reference number instead of the personal account information. The conventional communication can be modified a variety of ways in order to include the account reference number.

In some cases, the standard format of the communication can be used. In this case, the account reference number can be included in the communication in place of the personal account number. For example, the account reference number can have the same number of characters as the personal account number and can be included in a field assigned to the personal account number within the communication. The communication can include a notification (e.g., a flag) to notify the third-party system that the account reference number is included in the communication in place of the personal account number. Indeed, the data type of the field can be announced to indicate whether the account reference number or the personal account number is included.

In some cases, the standard format of the communication can be modified. For example, the account reference number can be appended as a field at the end of the communication, with other parts of the communication being according to an existing procedure. In this case, the field assigned to the personal account number would be left empty.

In some cases, after the account reference number is digitized, the bank system can receive a confirmation that the account reference number has been digitized from the third-party system. The confirmation can be performed in a variety of manners. In some cases, a communication specifically indicating success or failure can be sent to the bank system. In some cases, the confirmation can be implicitly performed, such as if the protocol calls for a communication to be sent only in the event of one of success or failure.

The digitized account reference token can be provisioned to one or more user devices, allowing a user to make mobile payments using the digitized account reference. When the user makes a mobile payment, the third-party system can receive transaction details, including at least the digitized account reference token, from an acquirer.

Once the third-party system receives the transaction details, including the digitized account reference token, the third-party system can communicate with the token vault to de-tokenize the digitized account reference token to determine the corresponding account reference number, and thus the financial institution or issuer, associated with the user and account reference number.

The bank system can then receive the transaction details and the account reference number from the third-party system. The communication between the third-party system and the bank system does not include any financial identity data. Indeed, the communication includes the account reference number instead of the actual personal account number, and the account reference number is not financial identity data.

The bank system can then determine the user's personal account number associated with the account reference number by communicating with the consumer account data resource. For example, using the received account reference number, the bank system can query the consumer account table in the consumer account data resource for the corresponding personal account number.

Once the bank system determines the user's personal account number, the bank system can then transfer the funds from the user's account to the acquirer, and thus the acquirer's account.

FIG. 5 illustrates components of a computing system that may be used in certain embodiments described herein. Referring to FIG. 5, system 500 may be implemented within a single computing device or distributed across multiple computing devices or sub-systems that cooperate in executing program instructions. The system 500 can include one or more blade server devices, standalone server devices, personal computers, routers, hubs, switches, bridges, firewall devices, intrusion detection devices, mainframe computers, network-attached storage devices, and other types of computing devices. The system hardware can be configured according to any suitable computer architectures such as a Symmetric Multi-Processing (SMP) architecture or a Non-Uniform Memory Access (NUMA) architecture.

The system 500 can include a processing system 510, which may include one or more processors and/or other circuitry that retrieves and executes software 520 from storage system 530. Processing system 510 may be implemented within a single processing device but may also be distributed across multiple processing devices or sub-systems that cooperate in executing program instructions.

Storage system(s) 530 can include any computer readable storage media readable by processing system 510 and capable of storing software 520. Storage system 530 may be implemented as a single storage device but may also be implemented across multiple storage devices or sub-systems co-located or distributed relative to each other. Storage system 530 may include additional elements, such as a controller, capable of communicating with processing system 510. Storage system 530 may also include storage devices and/or sub-systems on which data is stored. System 500 may access one or more storage resources in order to access information to carry out any of the processes indicated by software 520.

Software 520, including routines for performing processes, such as process 300 for a third-party system and process 400 for a bank system, may be implemented in program instructions and among other functions may, when executed by system 500 in general or processing system 510 in particular, direct the system 500 or processing system 510 to operate as described herein.

In embodiments where the system 500 includes multiple computing devices, the server can include one or more communications networks that facilitate communication among the computing devices. For example, the one or more communications networks can include a local or wide area network that facilitates communication among the computing devices. One or more direct communication links can be included between the computing devices. In addition, in some cases, the computing devices can be installed at geographically distributed locations. In other cases, the multiple computing devices can be installed at a single geographic location, such as a server farm or an office.

A communication interface 540 may be included, providing communication connections and devices that allow for communication between system 500 and other computing systems (not shown) over a communication network or collection of networks (not shown) or the air.

In some embodiments, system 500 may host one or more virtual machines.

Alternatively, or in addition, the functionality, methods and processes described herein can be implemented, at least in part, by one or more hardware modules (or logic components). For example, the hardware modules can include, but are not limited to, application-specific integrated circuit (ASIC) chips, field programmable gate arrays (FPGAs), system-on-a-chip (SoC) systems, complex programmable logic devices (CPLDs) and other programmable logic devices now known or later developed. When the hardware modules are activated, the hardware modules perform the functionality, methods and processes included within the hardware modules.

It should be understood that as used herein, in no case do the terms “storage media,” “computer-readable storage media” or “computer-readable storage medium” consist of transitory carrier waves or propagating signals. Instead, “storage” media refers to non-transitory media.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A method comprising:
receiving, from a first system, a communication comprising at least an account reference number, wherein the account reference number is not personal account information;
creating a digitized account reference token for the account reference number;
storing the digitized account reference token mapped to the account reference number in a token vault; and
provisioning the digitized account reference token to one or more user devices.

2. The method of claim 1, further comprising:
confirming that the digitized account reference token has been created.

3. The method of claim 1, wherein the communication further comprises a field assigned to a personal account number and a field assigned to the account reference number, the field assigned to the personal account number being empty.

4. The method of claim 1, wherein the account reference number is included in the communication in place of a personal account number, the personal account number being personal account information, wherein the account reference number has a same number of characters as the personal account number.

5. The method of claim 1, wherein the first system is a bank system.

6. The method of claim 1, wherein the communication further comprises a flag indicating the account reference number is included in the communication.

7. The method of claim 1, further comprising:
receiving, from an acquirer, transaction details including at least the digitized account reference token;
identifying the account reference number from the token vault using the digitized account reference token;
determining the first system corresponding to the account reference number; and
communicating the transaction details and the account reference number to the first system.

8. The method of claim 1, wherein the token vault does not include personal account information.

9. One or more computer-readable storage media having instructions stored thereon that when executed by a processing system, direct the processing system to:
receive, from a first system, a communication comprising at least an account reference number, wherein the account reference number is not personal account information;
create a digitized account reference token for the account reference number;
store the digitized account reference token mapped to the account reference number in a token vault; and
provision the digitized account reference token to one or more user devices.

10. The media of claim 9, wherein the instructions further direct the processing system to:
confirm that the digitized account reference token has been created.

11. The media of claim 9, wherein the communication further comprises a field assigned to a personal account number and a field assigned to the account reference number, the field assigned to the personal account number being empty.

12. The media of claim 9, wherein the account reference number replaces a personal account number in the communication, the personal account number being personal account information, wherein the account reference number has a same number of characters as the personal account number.

13. The media of claim 9, wherein the first system is a bank system.

14. The media of claim 9, wherein the communication further comprises a flag indicating the account reference number is included in the communication.

15. The media of claim 9, wherein the instructions further direct the processing system to:
receive, from an acquirer, transaction details including at least the digitized account reference token;
identify the account reference number from the token vault using the digitized account reference token;
determine the first system corresponding to the account reference number; and
communicate the transaction details and the account reference number to the first system.

16. The media of claim 9, wherein the token vault does not include personal account information.

17. A system comprising:
a processing system;
a storage system;
a data resource associated with the storage system;
a data set stored on the data resource, the data set providing at least a mapping of account reference numbers and personal account numbers, wherein the account reference numbers do not contain personal account information; and
instructions stored on the storage system that, when executed by the processing system, direct the processing system to at least:
receive a request to digitize a personal account number, the request comprising the personal account number;
identify, from the data set stored on the data resource, an account reference number corresponding to the personal account number;
provide a communication to a third-party system to digitize the account reference number, the communication comprising the account reference number; and
receive a confirmation that the account reference number has been digitized.

18. The system of claim 17, wherein the account reference number replaces the personal account number in the communication, the personal account number being personal account information, wherein the account reference number has a same number of characters as the personal account number.

19. The system of claim 17, wherein the communication further comprises a field assigned to the personal account number and a field assigned to the account reference number, the field assigned to the personal account number being empty.

20. The system of claim 17, wherein the communication further comprises a flag indicating the account reference number is included in the communication.
